(19) United States
(12) Patent Application Publication
(10) Pub. No.: US 2011/0167782 A1
(43) Pub. Date: Jul. 14, 2011

(54) SYSTEMS AND APPARATUS FOR A FUEL CONTROL ASSEMBLY FOR USE IN A GAS TURBINE ENGINE

(76) Inventors: Scott Arthur Tetzlaff, Simpsonville, SC (US); Edward Wayne Hardwick, JR., Simpsonville, SC (US); Vince Futia, Rennselaer, NY (US); Joseph Louis Gambino, Simpsonville, SC (US); Jay Lynn Johnson, Simpsonville, SC (US)

(21) Appl. No.: 12/686,940

(22) Filed: Jan. 13, 2010

(51) Int. Cl. F02C 9/26

(52) U.S. Cl. 60/39.281; 137/12

(57) ABSTRACT

A fuel control assembly for use in a gas turbine engine. The fuel control assembly includes a first trip device configured to selectively release a fluid pressure from a trip fluid system. At least one gas fuel control valve is coupled to the first trip device. The gas fuel control valve includes a second trip device for moving the gas fuel control valve to a safe position during a purge air operation.

### BACKGROUND OF THE INVENTION

The subject matter described herein relates generally to combustion systems for use with gas turbine engines and, more particularly, to a fuel control assembly for use in gas turbine engine combustion systems.

At least some known gas turbine engines include a compressor section, a combustor section, and at least one turbine section. The compressor compresses air, which is mixed with fuel and channeled to the combustor. The mixture is then ignited generating hot combustion gases. The combustion gases are channeled to the turbine which extracts energy from the combustion gases for powering the compressor, as well as producing useful work to power a load, such as an electrical generator, or to propel an aircraft in flight.

At least some known gas turbine engines operate in many different operating conditions, and combustor performance facilitates engine operation over a wide range of engine operating conditions. Controlling combustor performance may facilitate improving overall gas turbine engine operations. More specifically, controlling combustor performance may permit a larger variation in gas fuel composition, for example, heating value and specific gravity, while maintaining NOₓ emissions and combustion dynamics levels within predetermined limits. Gas turbines equipped with Dry Low NOₓ (DLN) combustion systems typically utilize fuel delivery systems that include multi-nozzle, premixed combustors. DLN combustor designs utilize lean premixed combustion to achieve low NOₓ emissions without using diluents such as water or steam.

Lean premixed combustion involves premixing the fuel and air upstream from the combustor flame zone and operation near the lean flammability limit of the fuel to keep peak flame temperatures and NOₓ production low. To deal with the stability issues inherent in lean premixed combustion and the wide fuel-to-air ratio range that occurs across the gas turbine operating range, at least some known DLN combustors typically include multiple gas fuel control valves. The gas turbine fuel system has a separately controlled delivery circuit to supply each gas fuel control valve. The control system varies the fuel flow (fuel split) to each gas fuel control valve over the turbine operating range to maintain flame stability, low emissions, and acceptable combustor life. The fuel split acts to divide the total fuel flow amongst the active gas fuel control valves to achieve the desired fuel flow to the combustor.

During operation of known gas turbine engines, often it is desirable to selectively close which gas fuel control valves are in operation. For example, in some engines, multiple fuel circuits are used to supply different fuels during different stages of operation. When selecting operation of a different fuel circuit, it is common to first purge the active fuel circuit of any excess fuel that may be present before activating the new circuit. This is accomplished in a purge air operation which flushes residual fuel from the fuel circuit. In known systems, at least one gas fuel control valve is moved to a closed position during the purge air operation. However, in known systems, during the purge air operation, it is possible for the gas fuel control valve to open upon receipt of an unanticipated or unplanned control signal. Opening such a valve during a purging operation may allow fuel to leak through the valve which may cause damage to the gas turbine engine. More specifically, fuel leaking into the purge air can be ignited and potentially damage the gas turbine engine. Accordingly, it is desirable to have a fuel control system that can hydro-mechanically close individual gas fuel control valves during a purge air operation.

### BRIEF DESCRIPTION OF THE INVENTION

In one aspect, a fuel control assembly for use in a gas turbine engine is provided. The fuel control assembly includes a first trip device configured to selectively release a fluid pressure from a trip fluid system. At least one gas fuel control valve is coupled to the first trip device. The gas fuel control valve includes a second trip device for moving the gas fuel control valve to a safe position during a purge air operation.

In another aspect, a gas turbine engine system is provided. The gas turbine engine system includes at least one combustor and a fuel control assembly coupled to the combustor and configured to regulate a fuel supply to the combustor. The fuel control assembly includes a first trip device that is configured to selectively release a fluid pressure from a trip fluid system. At least one gas fuel control valve is coupled to the first trip device. The gas fuel control valve includes a second trip device for moving the gas fuel control valve to a safe position during a purge air operation.

### BRIEF DESCRIPTION OF THE DRAWINGS

FIG. 1 is a schematic illustration of an exemplary gas turbine engine.

FIG. 2 is a schematic illustration of an exemplary fuel control assembly that may be used with the gas turbine engine shown in FIG. 1.

FIG. 3 is a schematic illustration of an alternative fuel control assembly that may be used with the gas turbine engine shown in FIG. 1.

### DETAILED DESCRIPTION OF THE INVENTION

While the systems and methods are herein described in the context of a gas turbine engine used in an industrial environment, it is contemplated that the systems and methods described herein may find utility in other combustion turbine systems applications including, but not limited to, turbines installed in aircraft. In addition, the principles and teachings set forth herein are applicable to gas turbine engines that operate with a variety of combustible fuels such as, but not limited to, natural gas, gasoline, kerosene, diesel fuel, and jet fuel. The description herein below is therefore set forth only by way of illustration, rather than limitation. Generally, the embodiments described herein facilitate selective control of at least one gas fuel control valve in a gas turbine engine by implementing features described herein.

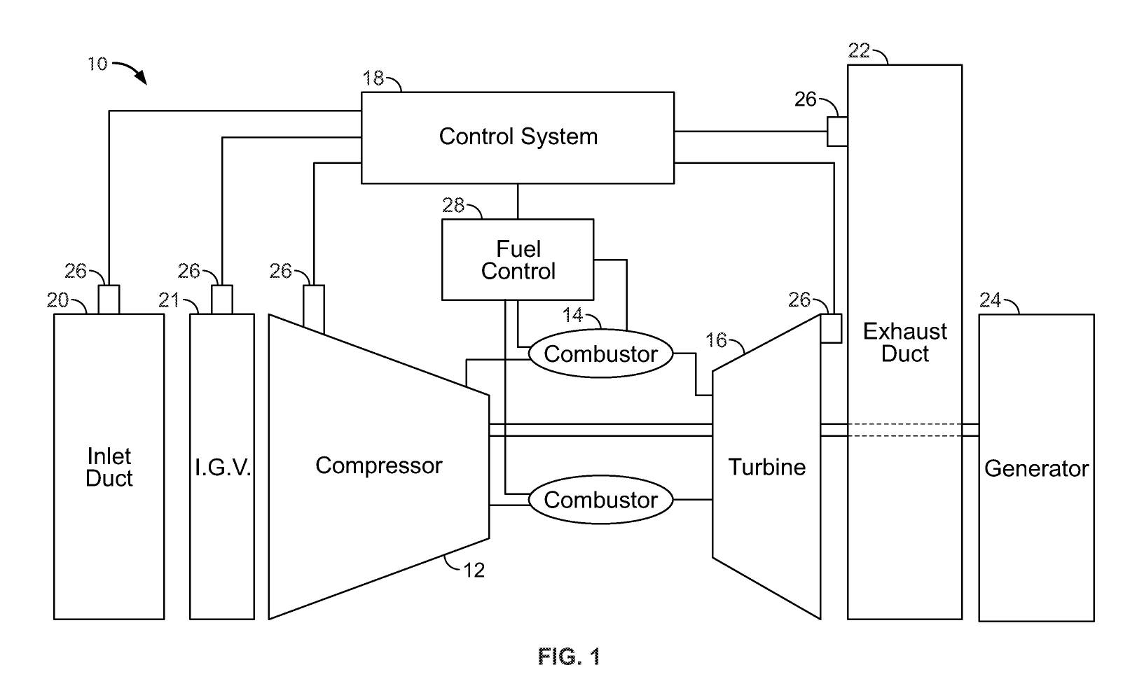

FIG. 1 is a schematic diagram of a gas turbine engine system 10. In the exemplary embodiment, gas turbine engine system 10 includes a compressor 12, at least one combustor 14, a turbine 16 drivingly coupled to compressor 12, a control system or controller 18, and a fuel control assembly 28. Combustor 14 is coupled to compressor 12 such that combustor 14 is in flow communication with compressor 12. Fuel control assembly 28 is coupled to combustor 14 and is configured to channel fuel into combustor 14. An inlet duct 20 channels ambient air to compressor 12. In one embodiment, injected water and/or other humidifying agents are also channeled to compressor 12 through inlet duct 20. Inlet duct 20 may include multiple ducts, filters, screens and/or sound absorbing devices that contribute to pressure losses of ambient air flowing through inlet duct 20 into one or more inlet guide vanes 21 of compressor 12.

During operation, inlet duct 20 channels air towards compressor 12. The inlet air is compressed to higher pressures and temperatures. The compressed air is discharged towards combustor 14 wherein it is mixed with fuel and ignited to generate combustion gases that flow to turbine 16, which drives compressor 12. Combustion gases are generated and channeled to turbine 16 wherein gas stream thermal energy is converted to mechanical rotational energy. Exhaust gases exit turbine 16 and flow through exhaust duct 22.

In the exemplary embodiment, an exhaust duct 22 channels combustion gases from turbine 16 through, for example, emission control, and/or sound absorbing devices. Exhaust duct 22 may include sound adsorbing materials and/or emission control devices that induce a backpressure to turbine 16. The amount of inlet pressure losses and backpressure may vary over time due to the addition of components to ducts 20, 22, and/or to the accumulation of dust and dirt clogging the inlet and/or exhaust ducts 20 and 22, respectively. Turbine 16 may drive a generator 24 that produces electrical power. The inlet losses to compressor 12 and turbine exhaust pressure losses tend to be a function of corrected flow through the gas turbine engine system 10. Moreover, the amount of inlet losses and turbine backpressure may vary with the flow rate through gas turbine engine system 10.

The operation of gas turbine engine system 10 may be monitored by several sensors 26 that detect various conditions of turbine 16, generator 24, and ambient environment. For example, temperature sensors 26 may monitor ambient temperature surrounding gas turbine engine system 10, compressor discharge temperature, turbine exhaust gas temperature, and other temperature measurements of the gas stream flowing through gas turbine engine system 10. Pressure sensors 26 may monitor ambient pressure, and static and dynamic pressure levels at inlet duct 20 at compressor 12, at exhaust duct 22, and/or at other locations in the gas stream defined within gas turbine engine system 10. Humidity sensors 26, such as wet and dry bulb thermometers, measure ambient humidity at the inlet duct 20. Sensors 26 may also include flow sensors, speed sensors, flame detector sensors, valve position sensors, guide vane angle sensors, and/or other sensors that sense various parameters relative to the operation of gas turbine engine system 10. As used herein, the term “parameters” refer to physical properties whose values can be used to define the operating conditions of gas turbine engine system 10, such as temperatures, pressures, and gas flows at defined locations.

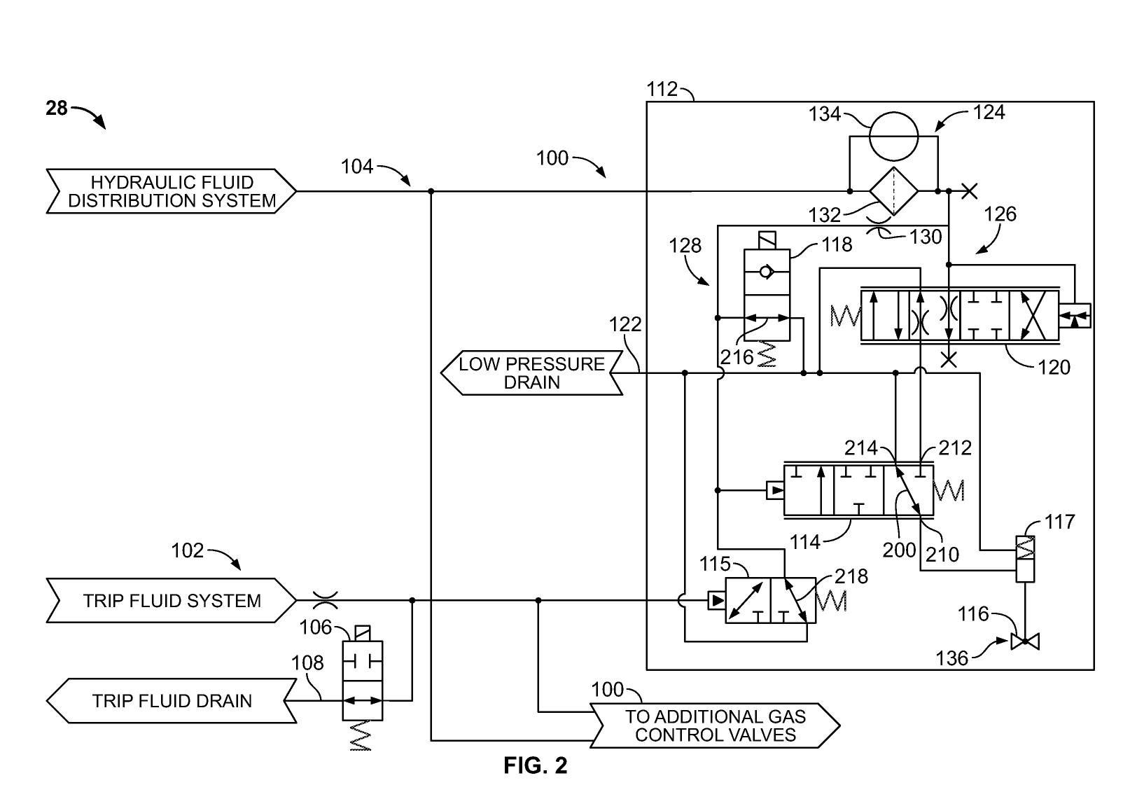

Fuel control assembly 28 is coupled to combustor 14 and regulates the fuel flowing from a fuel supply to combustor 14, and controls the split between the fuel flowing into various gas fuel control valves 100 (shown in FIG. 2) coupled about a combustion chamber defined in combustor 14. Fuel control assembly 28 may also select the type of fuel supplied to combustor 14. Fuel control assembly 28 may also generate and implement fuel split commands that determine an amount of fuel flowing to primary gas fuel control valves 100 and an amount of fuel flowing to secondary gas fuel control valves 100.

Control system 18 may be a computer system that includes at least one processor that executes programs to control the operation of gas turbine engine system 10 using sensor inputs and instructions from human operators. Programs executed by the control system 18 may include, for example, scheduling algorithms for regulating fuel flow to combustor 14. Commands generated by control system 18 cause fuel control assembly 28 to adjust gas fuel control valves 100 that regulate the flow, fuel splits, and type of fuel supplied to combustor 14, and to activate other control settings on gas turbine engine system 10.

In the exemplary embodiment, control system 18 regulates gas turbine engine system 10 based, in part, on algorithms stored in computer memory of control system 18. Such algorithms enable control system 18 to maintain the NOx and CO emissions in the turbine exhaust to within certain predefined emission limits, and to maintain the combustor firing temperature to within predefined temperature limits. The algorithms include inputs for parameter variables for current compressor pressure ratio, ambient specific humidity, inlet pressure loss, and turbine exhaust back pressure. Because of the parameters in inputs used by the algorithms, control system 18 accommodates seasonal variations in ambient temperature and humidity, and changes in the inlet pressure losses through the inlet duct 20 of gas turbine engine system 10 and in the exhaust backpressure at exhaust duct 22. Input parameters for ambient conditions, and inlet pressure losses and exhaust backpressure enable NO_{X}, CO and turbine firing algorithms executed in control system 18 to automatically compensate for seasonal variations in gas turbine engine system 10 operation and changes in inlet losses and in backpressure. Accordingly, the need is reduced for an operator to manually adjust a gas turbine engine system 10 to account for seasonal variations in ambient conditions and for changes in the inlet pressure losses or turbine exhaust backpressure.

In the exemplary embodiment, combustor 14 may be a DLN combustion system. Control system 18 may be programmed and modified to control the DLN combustion system and to determine fuel splits.

FIG. 2 is a schematic illustration of an exemplary fuel control assembly 28 that may be used with gas turbine engine system 10 (shown in FIG. 1). In the exemplary embodiment, fuel control assembly 28 includes a trip fluid system 102, a hydraulic fluid control system 104, a first or primary electric trip device 106, and at least one gas fuel control valve 100. Trip fluid system 102 supplies a flow of trip fluid at a predetermined positive pressure to the fuel control assembly 28. Hydraulic fluid control system 104 channels a flow of hydraulic fluid to fuel control assembly 28.

Primary electric trip device 106 is coupled to a trip fluid drain conduit 108 and channels trip fluid from trip fluid system 102 to trip fluid drain conduit 108. Control system 18 (shown in FIG. 1) is coupled to primary electric trip device 106 for controlling operation of primary electric trip device 106. Upon receiving a signal from control system 18, primary electric trip device 106 operates to selectively release fluid pressure in trip fluid system 102 by channeling trip fluid from trip fluid system 102 to trip fluid drain conduit 108. In one embodiment, control system 18 transmits a 125 volt direct current (DC) signal to primary electric trip device 106. In an alternative embodiment, control system 18 transmits one of a 120 volt alternating current (AC) signal, a 24 volt DC signal, and any other signal voltages that enable fuel control assembly 28 to function as described herein.

Gas fuel control valve 100 includes a housing enclosure 112 that contains a first or primary trip relay cartridge 114, a second or secondary trip relay cartridge 115, a gas valve 116, a hydraulic cylinder 117 coupled to gas valve 116, a second or secondary electric trip device 118, a servo valve 120, a low pressure drain line 122, and a hydraulic fluid filter assembly 124.

Hydraulic fluid control system 104 provides hydraulic fluid to gas fuel control valve 100 to enable operation of gas valve 116. Hydraulic fluid control system 104 includes a first or hydraulic operation circuit 126 and a second or hydraulic trip circuit 128. An orifice 130 is coupled to hydraulic fluid control system 104 and is between hydraulic operation circuit 126 and hydraulic trip circuit 128. Orifice 130 operates to maintain a suitable hydraulic pressure in hydraulic operation circuit 126 to facilitate operation of hydraulic cylinder 117 and gas valve 116. In the exemplary embodiment, orifice 130 facilitates maintaining a positive hydraulic pressure in hydraulic operation circuit 126 with a loss of hydraulic fluid and/or hydraulic fluid pressure in hydraulic trip circuit 128.

Hydraulic operation circuit 126 channels hydraulic fluid to hydraulic cylinder 117 for operating gas valve 116. Gas valve 116 is hydraulically-actuated and is movable between an open and a closed position. Servo valve 120 is coupled to hydraulic cylinder 117 and to hydraulic operation circuit 126 for regulating a flow of hydraulic fluid to hydraulic cylinder 117. Control system 18 is coupled to servo valve 120 for controlling operation of servo valve 120. Upon receiving a signal from control system 18, servo valve 120 operates to selectively release hydraulic fluid pressure in hydraulic cylinder 117 by channeling hydraulic fluid from hydraulic operation circuit 126 to gas valve 116. Gas valve 116 is selectively positionable between an open and a closed position after receiving a flow of hydraulic fluid from servo valve 120. As servo valve 120 channels hydraulic fluid to hydraulic cylinder 117, hydraulic cylinder 117 operates gas valve 116 to regulate the flow of fuel to combustor 14 (shown in FIG. 1).

Primary trip relay cartridge 114 is coupled to hydraulic trip circuit 128 and to hydraulic operation circuit 126. Primary trip relay cartridge 114 is movable upon a loss of hydraulic fluid pressure in hydraulic trip circuit 128. Primary trip relay cartridge 114 is coupled to hydraulic operation circuit 126 and between servo valve 120 and hydraulic cylinder 117 for controlling a flow of hydraulic fluid from servo valve 120 to hydraulic cylinder 117. Primary trip relay cartridge 114 releases hydraulic system pressure in hydraulic operation circuit 126 upon sensing a loss of hydraulic fluid pressure in hydraulic trip circuit 128. Primary trip relay cartridge 114 is further coupled to low pressure drain line 122 such that primary trip relay cartridge 114 channels hydraulic fluid from hydraulic operation circuit 126 through low pressure drain line 122 during a loss of hydraulic fluid pressure in hydraulic trip circuit 128.

Primary trip relay cartridge 114 is movable between a first or non-fail safe position (not shown) and a second or fail-safe position (shown in FIG. 2). In the non fail-safe position, primary trip relay cartridge 114 channels a flow of hydraulic fluid from servo valve 120 to hydraulic cylinder 117 to enable operation of gas valve 116. In the fail-safe position, primary trip relay cartridge 114 prevents a flow of hydraulic fluid from servo valve 120 to hydraulic cylinder 117 and channels a flow of hydraulic fluid from hydraulic cylinder 117 to low pressure drain line 122, such that a sufficient hydraulic pressure is prevented from being channeled to hydraulic cylinder 117 and to gas valve 116. In the exemplary embodiment, primary trip relay cartridge 114 is in non fail-safe position when a positive hydraulic pressure is channeled to primary trip relay cartridge 114 from hydraulic trip circuit 128. Upon a loss of hydraulic pressure from hydraulic trip circuit 128, primary trip relay cartridge 114 moves from the non fail-safe position to the fail safe position.

Hydraulic trip circuit 128 channels hydraulic fluid to secondary electric trip device 118, primary trip relay cartridge 114, and secondary trip relay cartridge 115. Secondary electric trip device 118 is coupled in flow communication with primary trip relay cartridge 114 and with secondary trip relay cartridge 115 via hydraulic trip circuit 128. Secondary electric trip device 118 is configured to selectively release fluid pressure from hydraulic trip circuit 128. Low pressure drain line 122 is coupled to secondary electric trip device 118 to enable secondary electric trip device 118 to channel hydraulic fluid from hydraulic trip circuit 128 through low pressure drain line 122. Control system 18 is coupled to secondary electric trip device 118 for controlling operation of secondary electric trip device 118 and is configured to transmit a signal to secondary electric trip device 118.

Secondary trip relay cartridge 115 is coupled in flow communication with primary trip relay cartridge 114 and with secondary electric trip device 118 via hydraulic trip circuit 128. Secondary trip relay cartridge 115 is further coupled to primary electric trip device 106 via trip fluid system 102. Secondary trip relay cartridge 115 is configured to selectively release fluid pressure from hydraulic trip circuit 128. Low pressure drain line 122 is coupled to secondary trip relay cartridge 115 to enable secondary trip relay cartridge 115 to channel hydraulic fluid from hydraulic trip circuit 128 through low pressure drain line 122. In the exemplary embodiment, secondary trip relay cartridge 115 facilitates maintaining a positive hydraulic pressure in hydraulic trip circuit 128 with a positive trip fluid pressure from trip fluid system 102. Upon a loss of trip fluid pressure from trip fluid system 102, secondary trip relay cartridge 115 channels a flow of hydraulic fluid from hydraulic trip circuit 128 to low pressure drain line 122 to facilitate a loss of hydraulic trip circuit hydraulic pressure in hydraulic trip circuit 128 and at primary trip relay cartridge 114.

Hydraulic fluid control system 104 channels hydraulic fluid through hydraulic fluid filter assembly 124 such that the hydraulic fluid is suitable for use in servo valve 120 and hydraulic cylinder 117. Hydraulic fluid filter assembly 124 includes a high-capacity filter 132 for filtering hydraulic fluid, and a visual indicator 134. High-capacity filter 132 facilitates removing large oil-borne contaminants, dirt, and debris from the hydraulic fluid. Visual indicator 134 indicates when the recommended pressure differential across hydraulic fluid filter assembly 124 has been exceeded, such that high-capacity filter 132 should be replaced.

In the exemplary embodiment, gas valve 116 includes a biasing member 136 that biases gas valve 116 to a safe position upon a loss of hydraulic pressure. Primary trip relay cartridge 114 is coupled to servo valve 120 to prevent a flow of hydraulic fluid from the servo valve 120 to gas valve 116 during a loss of hydraulic fluid pressure from hydraulic trip circuit 128. In the exemplary embodiment, a safe position for gas valve 116 is a fully closed position. In an alternative embodiment, a safe position for gas valve 116 is a fully open position, a partially opened positioned, or a partially closed position.

In the exemplary embodiment, primary trip relay cartridge 114 includes one or more two-position, hydraulically-operated valves 200, a gas valve port 210, a hydraulic fluid port 212, and a drain line port 214. Valve 200 is movable between a first position and a second position. In the first position, valve 200 is coupled in flow communication between hydraulic fluid port 212 and gas valve port 210, such that hydraulic operation circuit 126 is coupled in flow communication with hydraulic cylinder 117. In the second position (shown in FIG. 2), valve 200 is coupled between drain line port 214 and gas valve port 210 such that hydraulic cylinder 117 is coupled in flow communication with low pressure drain line 122. During operation, when primary trip relay cartridge 114 receives a positive hydraulic fluid pressure from hydraulic trip circuit 128, valve 200 moves to the first position, such that hydraulic fluid pressure is supplied to hydraulic cylinder 117 from hydraulic operation circuit 126. When hydraulic trip circuit hydraulic fluid pressure decreases, valve 200 moves to the second position, such that hydraulic cylinder 117 is isolated from hydraulic operation circuit 126, and such that hydraulic fluid pressure is decreased in hydraulic cylinder 117 and gas valve 116. As the hydraulic pressure decreases in hydraulic cylinder 117, biasing member 136 moves gas valve 116 to a safe position.

In the exemplary embodiment, secondary electric trip device 118 includes one or more electrically-operated valves 216. Valve 216 is movable between a first or energized position and a second or de-energized position. In first position, valve 216 is positioned to prevent a flow of hydraulic fluid from hydraulic trip circuit 128 through low pressure drain line 122 to facilitate a positive fluid pressure in hydraulic trip circuit 128. In the second position (shown in FIG. 2), valve 216 is positioned to channel a flow of hydraulic fluid from hydraulic trip circuit 128 through low pressure drain line 122. During operation, valve 216 is normally in the first position which enables positive hydraulic trip circuit fluid pressure to be provided to primary trip relay cartridge 114. Upon receipt of a first signal from control system 18, valve 216 moves to the first position, such that hydraulic trip circuit hydraulic fluid is prevented from being channeled from hydraulic trip circuit 128 through low pressure drain line 122, thus resulting in positive hydraulic trip circuit hydraulic fluid pressure at primary trip relay cartridge 114. Upon loss of the first signal from control system 18, valve 216 moves from the first position to the second position, such that hydraulic trip circuit hydraulic fluid is channeled from hydraulic trip circuit 128 through low pressure drain line 122, thus resulting in a decrease of hydraulic trip circuit hydraulic fluid pressure at primary trip relay cartridge 114. In an alternative embodiment, valve 216 moves from the first position to the second position upon receipt of a second signal from control system 18. In another embodiment, control system 18 is configured to transmit a 125 volt DC signal to secondary electric trip device 118.

In the exemplary embodiment, secondary trip relay cartridge 115 includes one or more two-position, hydraulically-operated valves 218. Valve 218 is movable between a first position and a second position. In the first position, valve 218 is positioned such that a flow of hydraulic fluid from hydraulic trip circuit 128 is prevented from being channeled through low pressure drain line 122, wherein a positive hydraulic fluid pressure in hydraulic trip circuit 128 is supplied to primary trip relay cartridge 114. In the second position (shown in FIG. 2), valve 218 is positioned such that hydraulic trip circuit 128 is coupled in flow communication with low pressure drain line 122, wherein hydraulic fluid pressure is released from hydraulic trip circuit 128 with a flow of hydraulic fluid channeled from hydraulic trip circuit 128 through low pressure drain line 122. Trip fluid system 102 is coupled to secondary trip relay cartridge 115 for providing a flow of trip fluid having a positive fluid pressure to secondary trip relay cartridge 115. During operation, secondary trip relay cartridge 115 is in the first position with a positive trip fluid pressure received from trip fluid system 102. Secondary trip relay cartridge 115 moves to the second position upon a loss of trip fluid pressure from trip fluid system 102.

During normal operation of gas turbine engine system 10, a variety of fuels may be supplied to fuel control assembly 28 from a fuel delivery system (not shown). Fuel control assembly 28 regulates the flow of fuel to combustor 14 through a plurality of gas fuel control valves 100. When a change in the type of fuel, or a change in the fuel mixture used in gas turbine engine system 10 occurs, excess fuel is removed from one or more gas fuel control valves 100 during a purge operation. This allows the previous fuel to be removed from the gas fuel control valve 100 allowing gas fuel control valve 100 to be ready to receive the new fuel mixture. During a purge operation, control system 18 transmits a signal to secondary electric trip device 118. Upon receipt of a signal from control system 18, secondary electric trip device 118 releases fluid pressure from hydraulic trip circuit 128 and discharges hydraulic fluid through low pressure drain line 122. As the hydraulic pressure is released from hydraulic trip circuit 128, primary trip relay cartridge 114 releases hydraulic fluid pressure from hydraulic operation circuit 126 and channels hydraulic fluid from hydraulic cylinder 117 through low pressure drain line 122. Upon a loss of fluid pressure in hydraulic cylinder 117, gas valve 116 is hydro-mechanically moved to a safe position by biasing member 136. The loss of pressure in hydraulic cylinder 117 ensures that gas valve 116 cannot be operated. As such, an unplanned control signal transmitted from control system 18 to servo valve 120 does not operate gas valve 116. Secondary electric trip device 118 operates to enable gas fuel control valve 100 to be safely closed independently of other gas fuel control valves, thus enabling continued operation of other gas fuel control valves during a purge operation of an individual gas fuel control valve 100, thus facilitating reducing the potential for an unplanned ignition event to occur during purge air operations.

During operation of gas turbine engine system 10, control system 18 monitors a number of operation parameters, such as but not limited to, temperature, exhaust pressure, and combustion emissions. As such control system 18 operates to shut-down gas turbine engine system 10 during periods in which gas turbine engine system 10 is not operating within normal operating parameters. During shutdown of gas turbine engine system 10 it is necessary to ensure that fuel control assembly 28 cannot operate to supply fuel to combustor 14. Control system 18 transmits a signal to primary electric trip device 106 which then operates to release trip fluid from trip fluid system 102, such that each gas fuel control valve 100 of fuel control assembly 28 experiences a loss of trip fluid pressure. Upon a loss of trip fluid pressure, each secondary trip relay cartridge 115 in each gas fuel control valve 100 operates to decrease hydraulic fluid pressure in hydraulic trip circuit 128. As the hydraulic pressure is released from hydraulic trip circuit 128, primary trip relay cartridge 114 releases hydraulic fluid pressure from hydraulic operation circuit 126, thus resulting in each gas valve 116 moving to a safe position, as described above. This operation enables each gas fuel control valve 100 to be hydro-mechanically moved to a safe position simultaneously.

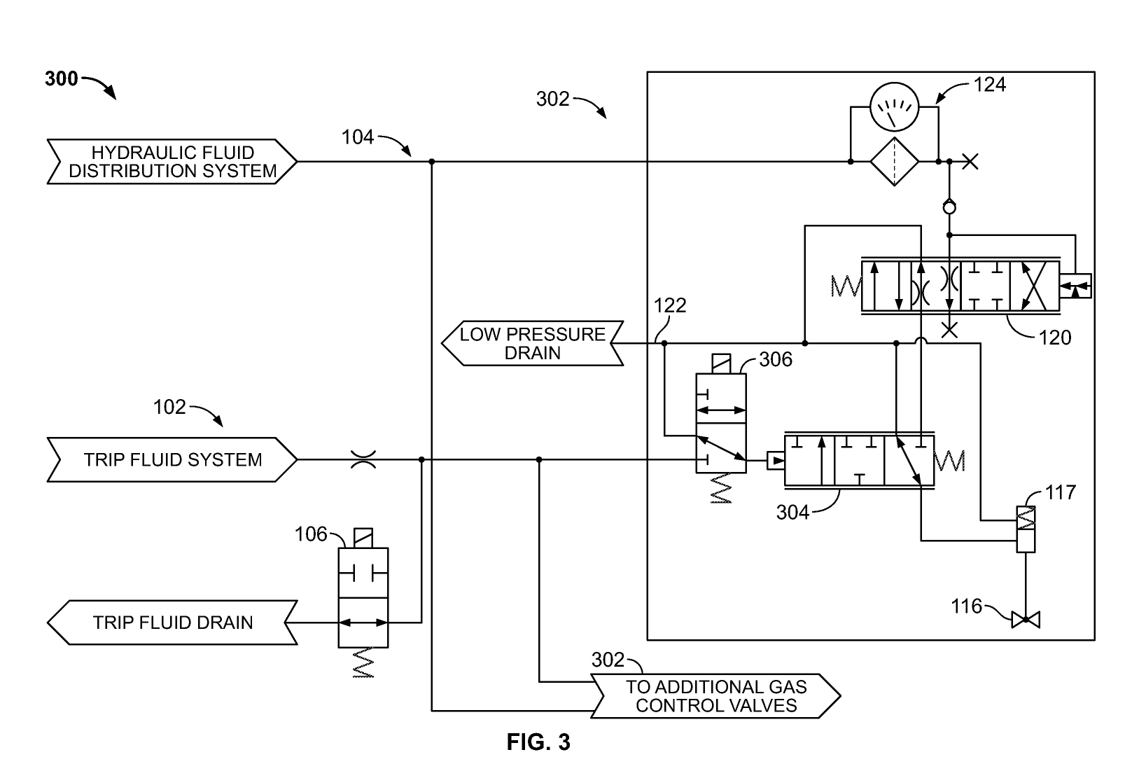

FIG. 3 is a schematic illustration of an alternative fuel control assembly 300 that may be used with gas turbine engine system 10. Components shown in FIG. 2 are labeled with the same reference numbers in FIG. 3. In the alternative embodiment, fuel control assembly 300 includes trip fluid system 102, hydraulic fluid control system 104, primary electric trip device 106, and a plurality of gas fuel control valves 302. Gas fuel control valve 302 includes a trip relay cartridge 304, a secondary electric trip device 306, gas valve 116, hydraulic cylinder 117, servo valve 120, low pressure drain line 122, and hydraulic fluid filter assembly 124. Trip relay cartridge 304 is coupled to trip fluid system 102 such that trip relay cartridge 304 is movable upon a loss of trip fluid pressure. Trip relay cartridge 304 is also coupled to hydraulic fluid control system 104 for releasing hydraulic system pressure upon sensing a loss of trip fluid pressure. Trip relay cartridge 304 is also coupled to low pressure drain line 122 such that trip relay cartridge 304 channels hydraulic fluid through low pressure drain line 122 during a loss of trip fluid pressure. Secondary electric trip device 306 is coupled to trip relay cartridge 304 and is configured to selectively release fluid pressure from trip fluid system 102. Low pressure drain line 122 is coupled to secondary electric trip device 306 to enable secondary electric trip device 306 to channel trip fluid through low pressure drain line 122.

In the alternative embodiment, trip relay cartridge 304 is movable between a first position and a second position. In the first position, trip relay cartridge 304 provides flow communication between hydraulic fluid control system 104 and hydraulic cylinder 117. In the second position (shown in FIG. 3), trip relay cartridge 304 substantially prevents a flow of hydraulic fluid from hydraulic fluid control system 104 to hydraulic cylinder 117 and channels a flow of hydraulic fluid from hydraulic cylinder 117 through low pressure drain line 122.

In the alternative embodiment, secondary electric trip device 306 is movable between a first position and a second position. In first position, secondary electric trip device 306 provides flow communication between trip fluid system 102 and trip relay cartridge 304, wherein trip fluid pressure is supplied to trip relay cartridge 304. In the second position (shown in FIG. 3), secondary electric trip device 306 substantially prevents a flow of trip fluid to trip relay cartridge 304 and channels a flow of trip fluid from trip relay cartridge 304 through low pressure drain line 122. During operation, with secondary electric trip device 306 in the first position, a positive trip fluid pressure is channeled to trip relay cartridge 304 via trip fluid system 102. With secondary electric trip device 306 in the second position, trip fluid is channeled from trip relay cartridge 304 through low pressure drain line 122, thus resulting in a decrease of trip fluid pressure at trip relay cartridge 304. Upon a loss of trip pressure, trip relay cartridge 304 channels hydraulic fluid from hydraulic cylinder 117 through low pressure drain line 122, thereby preventing operation of gas valve 116.

The fuel control assembly described herein facilitates reducing damage to a gas turbine engine system by facilitating reducing the potential for an unplanned ignition event during a purge air operation. More specifically, the methods and systems described herein facilitate reducing hydraulic pressure to an individual gas valve and hydro-mechanically moving the gas valve to a safe position, such that an unplanned signal from the control system to a servo valve does not operate the gas valve during a purge air operation, which may otherwise result in an unplanned ignition event. As such, the operational life of the gas turbine engine assembly is facilitated to be extended, which results in potential reduced repair and maintenance costs of gas turbine engine systems.

The above-described systems and methods facilitate individually hydro-mechanically moving gas fuel control valves to a safe position during purge air operations. As such, the embodiments described herein facilitate reducing the potential for an unplanned ignition event to occur during purge air operations. Specifically, hydro-mechanically moving a gas fuel control valve to a safe position facilitates reducing the potential for an unplanned control signal to operate the gas fuel control valve during a purge air operation. As such, the performance life of the gas turbine engine can be extended because of the reduction in damage that may occur over the operational life of the gas turbine engine.

Exemplary embodiments of systems and methods of assembling a fuel control assembly for use in a gas turbine are described above in detail. The systems and methods are not limited to the specific embodiments described herein, but rather, components of systems and/or steps of the method may be utilized independently and separately from other components and/or steps described herein. For example, the systems and method may also be used in combination with other combustion systems and methods, and are not limited to practice with only the gas turbine engine as described herein. Rather, the exemplary embodiment can be implemented and utilized in connection with many other combustion system applications.

Although specific features of various embodiments of the invention may be shown in some drawings and not in others, this is for convenience only. In accordance with the principles of the invention, any feature of a drawing may be referenced and/or claimed in combination with any feature of any other drawing.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A fuel control assembly for use in a gas turbine engine, said fuel control assembly comprising:
a first trip device configured to selectively release a fluid pressure from a trip fluid system; and
at least one gas fuel control valve coupled to said first trip device, said gas fuel control valve comprising a second trip device for moving said gas fuel control valve to a safe position during a purge air operation.

2. A fuel control assembly in accordance with claim 1, further comprising a hydraulic fluid control system coupled to said gas fuel control valve, said second trip device is configured to release fluid pressure from said hydraulic fluid control system.

3. A fuel control assembly in accordance with claim 2, wherein said gas fuel control valve further comprises a gas valve coupled to said second trip device, said gas valve is biased to a safe position upon a loss of fluid pressure from said hydraulic fluid control system.

4. A fuel control assembly in accordance with claim 3, wherein said hydraulic fluid control system comprises a first fluid circuit and a second fluid circuit, said gas valve is coupled to said first fluid circuit, said second trip device is coupled to said second fluid circuit for releasing fluid pressure from said second fluid circuit.

5. A fuel control assembly in accordance with claim 4, wherein said gas fuel control valve further comprises a first trip relay cartridge coupled to said second trip device and to said gas valve, said first trip relay cartridge is configured to release fluid pressure from said first fluid circuit upon a loss of fluid pressure from said second fluid circuit, wherein said gas valve is biased to a safe position upon a loss of fluid pressure from said first fluid circuit.

6. A fuel control assembly in accordance with claim 5, wherein said gas fuel control valve further comprises a low pressure drain line, said first trip relay cartridge is configured to channel hydraulic fluid from said first fluid circuit through said low pressure drain line during a loss of fluid pressure from said second fluid circuit.

7. A fuel control assembly in accordance with claim 4, wherein said gas fuel control valve further comprises a low pressure drain line, said second trip device is configured to channel hydraulic fluid from said second fluid circuit through said low pressure drain line.

8. A fuel control assembly in accordance with claim 5, wherein said gas fuel control valve further comprises a second trip relay cartridge coupled to said second trip device and to said first trip relay cartridge, said second trip relay cartridge is configured to release fluid pressure from said second fluid circuit upon a loss of trip fluid pressure from said trip fluid system.

9. A fuel control assembly in accordance with claim 5, wherein said gas fuel control valve further comprises a servo valve coupled to said gas valve for regulating a flow of hydraulic fluid from said first fluid circuit to said gas valve, said first trip relay cartridge is coupled to said servo valve to prevent a flow of hydraulic fluid from said servo valve during a loss of fluid pressure from said second fluid circuit.

10. A fuel control assembly in accordance with claim 1 further comprising a control system coupled to said second trip device for controlling operation of said second trip device, said second trip device is configured to release fluid pressure from said hydraulic fluid control system in response to a signal received from said control system.

11. A fuel control assembly in accordance with claim 1 further comprising a control system coupled to said first trip device for controlling operation of said first trip device, said first trip device is configured to release fluid pressure in said trip fluid system in response to a signal received from said control system.

12. A fuel control assembly in accordance with claim 1, wherein said gas fuel control valve further comprises a gas valve coupled to said second trip device, said second trip device is configured to release fluid pressure from said trip fluid system, said gas valve is biased to a safe position upon a loss of trip fluid pressure from said trip fluid system.

13. A gas turbine engine system comprising:
at least one combustor; and
a fuel control assembly coupled to said combustor and configured to regulate a fuel supply to said combustor, said fuel control assembly comprising:
a first trip device configured to selectively release a fluid pressure from a trip fluid system; and
at least one gas fuel control valve coupled to said first trip device, said gas fuel control valve comprising a second trip device for moving said gas fuel control valve to a safe position during a purge air operation.

14. A gas turbine engine system in accordance with claim 13, wherein said fuel control assembly further comprises a hydraulic fluid control system coupled to said gas fuel control valve, said second trip device is configured to release fluid pressure from said hydraulic fluid control system.

15. A gas turbine engine system in accordance with claim 14, wherein said gas fuel control valve further comprises a gas valve coupled to said second trip device, said gas valve is biased to a safe position upon a loss of fluid pressure from said hydraulic fluid control system.

16. A gas turbine engine system in accordance with claim 15, wherein said hydraulic fluid control system comprises a first fluid circuit and a second fluid circuit, said gas valve is coupled to said first fluid circuit, said second trip device is coupled to said second fluid circuit for releasing fluid pressure from said second fluid circuit.

17. A gas turbine engine system in accordance with claim 16, wherein said gas fuel control valve further comprises a first trip relay cartridge coupled to said second trip device and to said gas valve, said first trip relay cartridge is configured to release fluid pressure from said first fluid circuit upon a loss of fluid pressure from said second fluid circuit, wherein said gas valve is biased to a safe position upon a loss of fluid pressure from said first fluid circuit.

18. A gas turbine engine system in accordance with claim 17, wherein said gas fuel control valve further comprises a second trip relay cartridge coupled to said second trip device and to said first trip relay cartridge, said second trip relay cartridge is configured to release fluid pressure from said second fluid circuit upon a loss of trip fluid pressure from said trip fluid system.

19. A gas turbine engine system in accordance with claim 17, wherein said gas fuel control valve further comprises a servo valve coupled to said gas valve for regulating a flow of hydraulic fluid from said first fluid circuit to said gas valve, said first trip relay cartridge is coupled to said servo valve to prevent a flow of hydraulic fluid from said servo valve during a loss of fluid pressure from said second fluid circuit.

20. A gas turbine engine system in accordance with claim 13, wherein said gas fuel control valve further comprises a gas valve coupled to said second trip device, said second trip device is configured to release fluid pressure from said trip fluid system, said gas valve is biased to a safe position upon a loss of trip fluid pressure from said trip fluid system.
